(19) United States
(12) Patent Application Publication
(10) Pub. No.: US 2006/0168798 A1
(43) Pub. Date: Aug. 3, 2006

(54) Method of lapping row bar in which perpendicular magnetic heads are formed and lapping machine

(75) Inventor: Hiroyuki Naka, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/342,668

(22) Filed: Jan. 31, 2006

(30) Foreign Application Priority Data
Jan. 31, 2005 (JP) 2005-023899

(51) Int. Cl. G11B 5/127

(52) U.S. Cl. 29/603.16; 29/603.01; 29/603.12

(57) ABSTRACT

According to one embodiment, there is provided a method of lapping a row bar in which perpendicular magnetic heads each including a read element as well as a main pole and a return yoke are formed. The method includes preparing a row bar in which first lapping guides are formed close to the read element and second lapping guides are formed close to the main pole, mounting the row bar on a lapping machine so as to allow a lapping surface of the row bar to face a lapping plate, and carrying out lapping while controlling pressure applied to the row bar on the basis of resistance values of the first and second lapping guides.

### CROSS-REFERENCE TO RELATED APPLICATIONS

This application is based upon and claims the benefit of priority from prior Japanese Patent Application No. 2005-023899, filed Jan. 31, 2005, the entire contents of which are incorporated herein by reference.

### BACKGROUND

1. Field

One embodiment of the present invention relates to a method for lapping a row bar in which perpendicular magnetic heads are formed and to a lapping machine.

2. Description of the Related Art

In manufacturing a head slider including a perpendicular magnetic head, a process of lapping a row bar, in which perpendicular magnetic heads each including a read element as well as a main pole and a return yoke are formed, is carried out.

In this lapping method, a row bar is prepared in which lapping guides (resistive elements) are formed close to a read element to control a lapping depth while monitoring resistance values of the lapping guides (see, for example, Jpn. Pat. Appln. KOKAI Publication Nos. 2004-47079 and 2001-14617). Monitoring the resistance values of the lapping guides enables to improve processing accuracy of a stripe height of the read element, i.e., a height of the read element from the lapping surface.

Because only a pair of lapping guides is formed on both sides of the read element in the prior art, however, deviation in lapping depth becomes greater in proportion to a distance from the read element. Thus, it is difficult to carry out even lapping of the entire lapping surface. In particular, when an inclination is brought about on the lapping surface between the read element and the main pole (or the return yoke), it is difficult to control the dimensions of the main pole and the return yoke which are the most important parameters contributing to write performance, leading to a problem of dispersion in the write performance.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not limited the scope of the invention.

FIG. 1 is a perspective view showing a magnetic disk apparatus;

FIG. 2 is a cross-sectional view of a perpendicular write head;

FIG. 3A is a front view of a main pole of the perpendicular write head, and FIG. 3B is a side view of a return yoke of the perpendicular write head;

FIG. 4 is a plan view of a wafer for use in manufacture of a magnetic head;

FIG. 5 is a schematic diagram of a lapping machine according to an embodiment of the present invention;

FIG. 6 is a schematic diagram for explanation of a conventional lapping method;

FIG. 7A is a graph showing variations of MWW with respect to NH using TH as a parameter, and FIG. 7B is a graph showing variations of OW with respect to NH using TH as a parameter;

FIG. 8 is a schematic diagram for explanation of a lapping method in a first embodiment of the present invention;

FIG. 9 is a flowchart of a lapping method according to an embodiment of the present invention;

FIG. 10 is a schematic diagram for explanation of a lapping method in a second embodiment of the present invention; and

FIG. 11 is a schematic diagram for explanation of a lapping method in a third embodiment of the present invention.

### DETAILED DESCRIPTION

Various embodiments according to the invention will be described hereinafter with reference to the accompanying drawings. In general, according to one embodiment of the present invention, there is provided a method of lapping a row bar in which perpendicular magnetic heads each including a read element as well as a main pole and a return yoke are formed, the method comprising: preparing a row bar in which first lapping guides are formed close to the read element and second lapping guides are formed close to the main pole; mounting the row bar on a lapping machine so as to allow a lapping surface of the row bar to face a lapping plate; and carrying out lapping while controlling pressure applied to the row bar on the basis of resistance values of the first and second lapping guides.

According to another embodiment of the present invention, there is provided a lapping machine lapping a row bar in which perpendicular magnetic heads each including a read element as well as a main pole and a return yoke, first lapping guides close to the read element, and at least ones of second lapping guides close to the main pole and third lapping guides on a trailing side of the return yoke are formed, comprising: a lapping plate; a jig which holds the row bar with a lapping surface thereof facing to the lapping plate; pistons which press the row bar through the jig; and a controller connected to the first lapping guides, at least ones of the second lapping guides and the third lapping guides, and the pistons, which controls operations of the pistons on the basis of resistance values of the first lapping guides, and resistance values of at least ones of the second lapping guides and the third lapping guides.

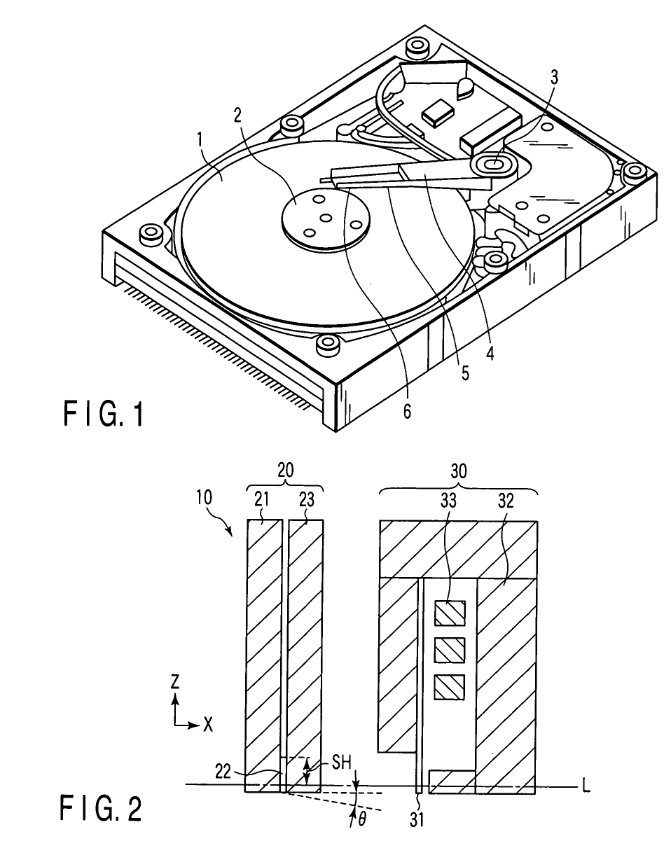

FIG. 1 is a perspective view showing a magnetic disk apparatus. A magnetic disk 1 is mounted rotatably onto a spindle motor 2. An actuator arm 4 is fitted to a pivot 3 provided in the vicinity of the magnetic disk 1, a suspension 5 is fitted to the actuator arm 4, and a head slider 6 is supported by the suspension 5. A perpendicular magnetic head including a read element as well as a main pole and a return yoke is formed at the tip of the head slider 6 so as to face the magnetic disk 1. Signals from the magnetic head are processed by a built-in signal processing unit.

FIG. 2 shows a cross-sectional view of an example of a perpendicular write head. Note that, in some figures shown hereinafter, x, y, and z denote the circumferential direction (downtrack direction) of the magnetic disk, the radial direction of the magnetic disk, and the height direction viewed from the magnetic disk, respectively. FIG. 2 shows a read head 20 and a write head 30 which constitutes a perpendicular magnetic head 10. The read head 20 has a structure in which a read element (GMR element) 22 is sandwiched between a pair of shields 21 and 23. The write head 30 includes a main pole 31, a return yoke 32, and a coil 33. The write head 30 shown here is a type that the return yoke 32 is positioned on the trailing side with respect to the main pole 31 (which is generally referred to as a shielded pole). However, a monopole-type write head, in which a return yoke is positioned on the leading side with respect to the main pole, may be used. Further, a configuration of the coil 33 may be different from that in FIG. 2. In FIG. 2, reference symbol L denotes the lapping surface, i.e., the air bearing surface (ABS). The height of the read element 22 from the lapping surface is referred to as the stripe height (SH).

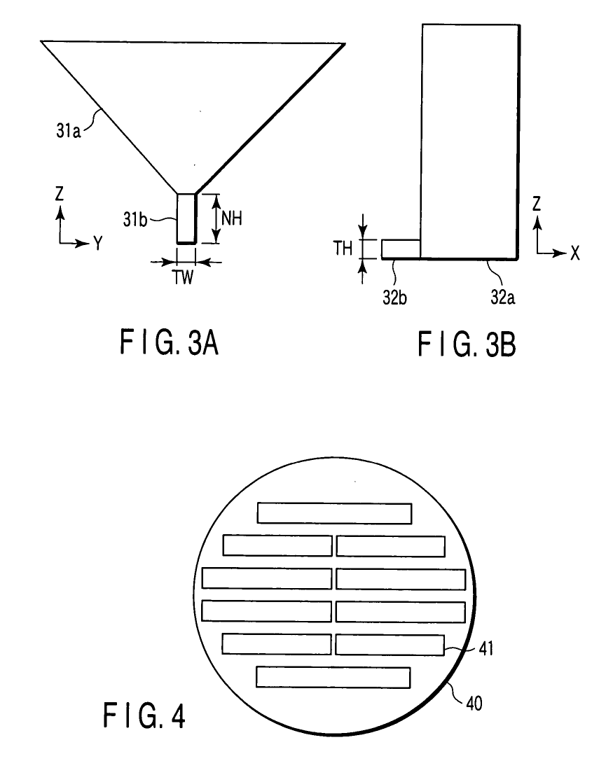

FIG. 3A is a front view of a film surface of the main pole 31. The main pole 31 has a flare yoke 31a and a tip portion 31b from the narrowed portion of the flare yoke 31a to the tip end. The height of the tip portion 31b is referred to as the neck height (NH), and the width of the tip portion 31b is referred to as the track width (TW).

FIG. 3B is a side view of only the return yoke 32 viewed from the same direction as in FIG. 2. The return yoke 32 has a return yoke main body 32a and a protruded portion 32b which defines the gap with the main pole 31. The height of the protruded portion 32b is referred to as the throat height (TH).

Next, a lapping method according to an embodiment of the present invention will be described.

As shown in FIG. 4, first, the structure of the read and write heads is formed by depositing thin films of various materials on the surface of a wafer 40 and processing the thin films into a desired pattern. Regions 41 including an array of magnetic heads are formed on the wafer 40. Bar-like members are provided by cutting out the regions 41. The bar-like member is referred to as a row bar. A section of the row bar, which corresponds to the lapping surface L shown in FIG. 2, is lapped.

FIG. 5 shows a schematic diagram of a lapping machine according to an embodiment of the present invention. In this lapping machine 50, a jig 52 which holds a row bar 45 is arranged above a lapping plate 51, and pistons 53 are brought into contact with the upper portion of the jig 52. The pistons 53 are preferably arranged above the respective elements included in the row bar 45. The operation of each piston 53 is controlled by a controller 55. The piston 53 has a mechanism that allows a position of pressure application surface to freely change with respect to the row bar 45. The row bar 45 is arranged such that the lapping surface is positioned substantially parallel to the top face of the lapping plate 51. Lapping is carried out with supplying abrasive material such as diamond slurry to between the row bar 45 and the lapping plate 51. In this lapping step, lapping is carried out while monitoring resistances of resistive elements referred to as electronic lapping guides (ELGs) in order to adjust a stripe height (SH) of the read element.

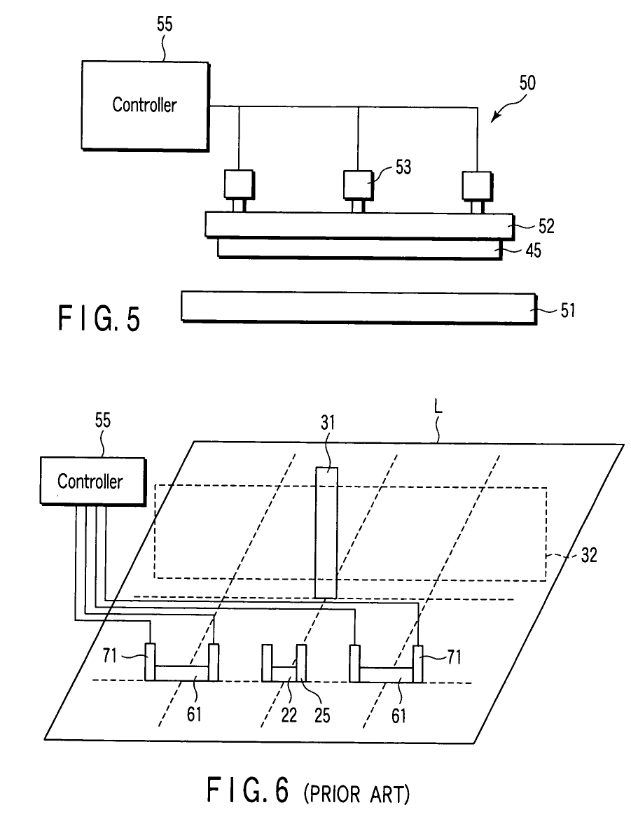

FIG. 6 schematically shows a state that a row bar including electronic lapping guides (ELGs) is set to a lapping machine according to a prior art. This figure shows a case of lapping a row bar in which a shielded pole-type perpendicular write head is formed. In this case, the main pole 31 and the return yoke 32 are arranged on the trailing side of the read element 22, and leads 25 are connected to the both ends of the read element 22. Two ELGs 61 are formed close to the both sides of the read element 22, and leads 71 are connected to the respective ELGs 61. The respective leads 71 are connected to the controller 55. The controller 55 monitors the resistance values of the ELGs 61 and adjusts SH of the read element 22 by carrying out lapping control.

In the conventional method shown in FIG. 6, SH of the read element 22 can be precisely processed by lapping. Because the ELGs 61 are only provided close to the read element 22, however, there is a possibility that deviation in lapping depth becomes greater in proportion to a distance from the read element 22. Namely, it is difficult to carry out even lapping of the entire lapping surface. In particular, when an inclination is brought about on the lapping surface between the read element 22 and the main pole 31 (or the return yoke 32), it is difficult to control NH of the main pole 31 and TH of the return yoke 32 which are the most important parameters contributing to write performance of the write head, leading to dispersion in the write performance.

Here, as shown in FIG. 2, assuming that S is a distance from the center of the read element 22 to the center of the main pole 31 (or the return yoke 32) and that θ is an inclination angle of the lapping surface in the x direction measured at the center of the main pole 31 (or the return yoke 32) with respect to the center of the read element 22, where the sign of the inclination angle is set to plus when the lapping is made deeper in the former position than in the read element 22, the deviation of NH (or TH) is represented by the formula: S×tan θ.

For example, given that S is 7 μm, if only the lapping surface is inclined by 1° in the x-direction, NH (or TH) is deviated as much as 0.12 μm. Because NH of the main pole 31 and TH of the return yoke 32 are designed in an order of 0.1 to 0.3 μm, even dispersion of only several tens of nm exerts an extremely profound effect on the write performance.

Recording to a magnetic disk is carried out using each of various magnetic heads which are fabricated through the lapping step according to the conventional method, and a magnetic write width (MWW) and overwrite characteristics (OW) are evaluated for each magnetic head. Here, OW is evaluated based on remaining high-frequency signals when low-frequency signals are overwritten onto high-frequency signals.

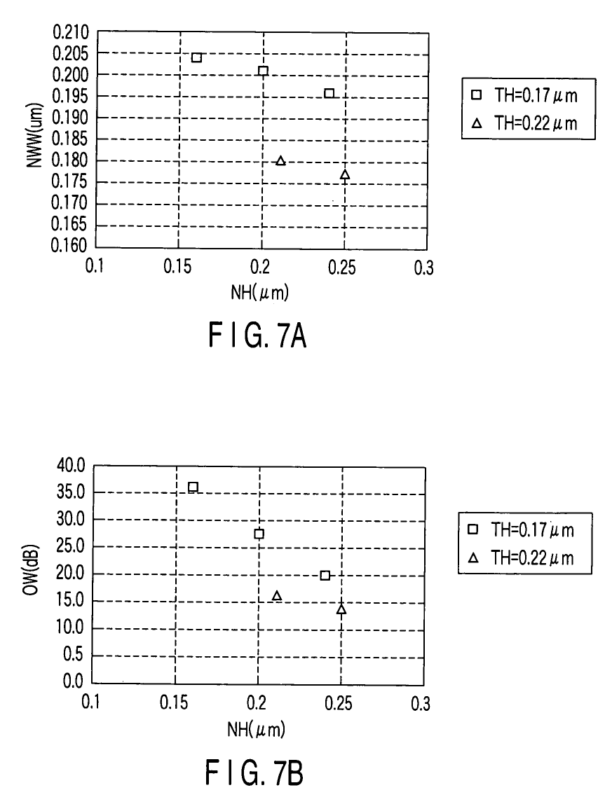

FIG. 7A shows variations of MWW with respect to NH using TH as a parameter, and FIG. 7B shows variations of OW with respect to NH using TH as a parameter. The transverse axes of the respective graphs denote measured values of NH.

As shown in FIGS. 7A and 7B, it can be understood that, when NH or TH is varied, a profound effect is brought about on MWW and OW characteristics. Because, in the conventional method, dispersion is brought about in NH or TH due to an inclination of the lapping surface, there is a possibility that desired MWW and OW characteristics cannot be obtained. If lapping of the main pole and the return yoke is too deeper than that of the read element, NH and TH become shorter, and if lapping of the main pole and the return yoke is too shallow, NH and TH become longer. When NH and TH become shorter, OW characteristics are improved, but MWW is made broader. In this case, the magnetic field intensity becomes higher as NH and TH become shorter, which brings about unfavorable fringe characteristics. Therefore, there is a possibility that the fabricated magnetic head does not satisfy desired write performance. It is understood that the above fact greatly affects the yield of the magnetic head.

In accordance with various specifications such as media characteristics, a track density and a linear density, dispersion in MWW and OW should preferably be kept at 5 nm or less and 5 dB or less, respectively. In order to allow the dispersion in MWW and OW to fall within the above ranges, the dispersion must be controlled such that differences between the maximum and minimum values of NH and TH are made to be 30 nm or less on the basis of the results of FIGS. 7A and 7B. Accordingly, the following condition should preferably be satisfied:
S|tan θ|<30 (nm),

where the distance S and inclination angle θ are as defined with reference to FIG. 2.

Hereinafter, embodiments of the present invention will be described with reference to the accompanying drawings.

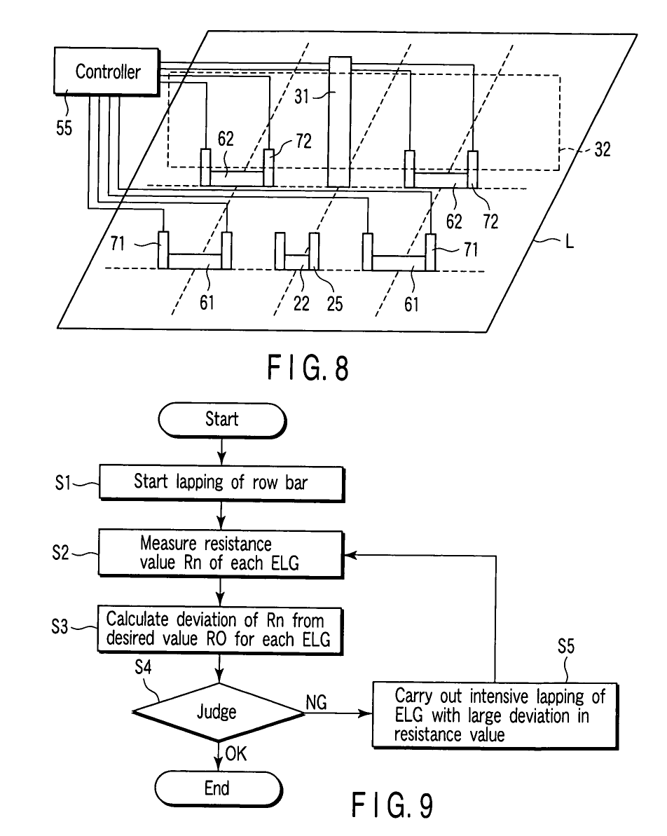

FIG. 8 schematically shows a state that a row bar including first and second ELGs is set to a lapping machine in a first embodiment of the present invention. This figure shows a case of lapping a row bar in which a shielded pole-type perpendicular write head is formed. In this case, the main pole 31 and the return yoke 32 are arranged on the trailing side of the read element 22, and leads 25 are connected to the both ends of the read element 22. A pair of first ELGs 61 is formed close to the both sides of the read element 22, and leads 71 are connected to the respective first ELGs 61. A pair of second ELGs 62 is formed close to the both sides of the main pole 31, and leads 72 are connected to the respective second ELGs 62. The respective leads 71 and 72 are connected to the controller 55. The first ELGs 61 and the second ELGs 62 are resistive elements, and are preferably elements having the same structure as that of the read element 22. Also, the leads 71 and 72 are preferably made of the same material as that of the leads 25 for the read element. The widths of the first ELGs 61 and the second ELGs 62 are preferably as broad as possible with respect to TW of the read element 22 at a level at which it is possible to suppress dispersion to a minimum. Because the widths of the first ELGs 61 and the second ELGs 62 are given, the lapping depth can be calculated on the basis of the resistance values of the first ELGs 61 and the second ELGs 62, which are monitored by the controller 55. The controller 55 adjusts SH of the read element 22 by carrying out lapping control while monitoring the resistance values of the first ELGs 61. The controller 55 also monitors the resistance values of the first ELGs 61 and the second ELGs 62. When a difference occurs between the resistance values of the both, the controller can adjust TH of the main pole 31 by carrying out lapping control in such a manner that a feedback circuit in the controller 55 is brought into an operation to apply pressure onto a portion of the jig above an ELG having great deviation from a desired resistance value by means of a particular piston 53 (see FIG. 5).

An outlined process flow of the lapping method in the present embodiment will be shown in FIG. 9. After starting the lapping (S1), the resistance values of the respective ELGs are measured at any time (S2). A deviation of a resistance value Rₙ from a desired value R₀ is calculated for each ELG (S3) to judge whether a desired resistance value is obtained (S4). When the desired resistance value has been obtained, the process is completed. When the desired resistance value has not been obtained, lapping control is carried out by applying pressure intensively onto a portion of the jig above an ELG having a great deviation by means of a particular piston 53 (S5). Necessary steps are repeated until a desired resistance value is obtained finally.

In accordance with the above process, the final inclination of the lapping surface of the row bar can be made so as to satisfy the condition: S1 tan θ1<10 (nm). It can be easily confirmed by a cross-sectional SEM or the like whether the inclination of the lapping surface satisfies the above condition.

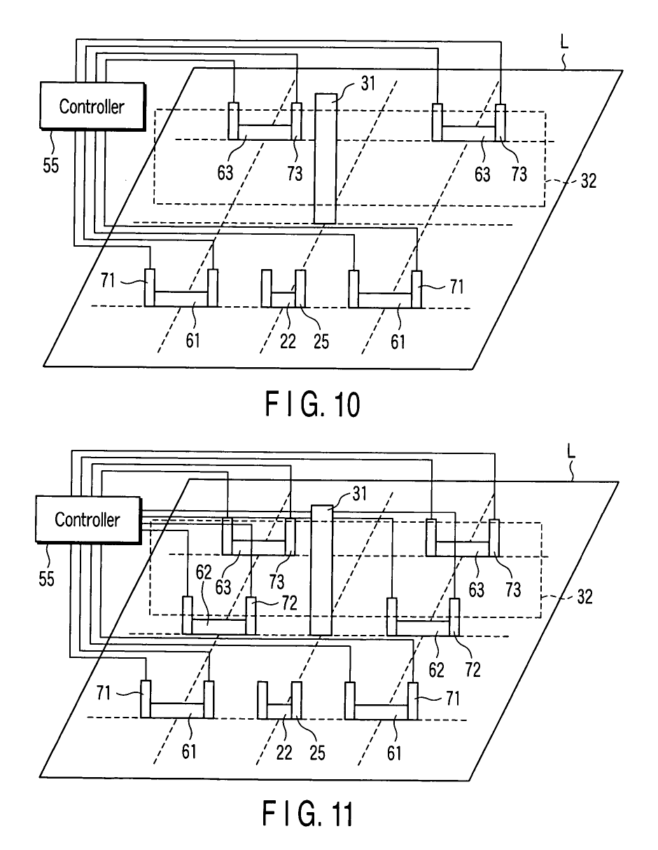

FIG. 10 schematically shows a state that a row bar including first and third ELGs is set to a lapping machine in a second embodiment of the present invention. In the same way as in FIG. 8, the perpendicular write head is of a shielded pole type. A pair of first ELGs 61 is formed close to the both sides of the read element 22, and leads 71 are connected to the respective first ELGs 61. Further, a pair of third ELGs 63 is formed on the trailing side of the return yoke 32, and leads 73 are connected to the respective third ELGs 63. Note that the third ELG 63 may be arranged only one on the center line in the downtrack direction with respect to the read element 22 and the main pole 31. This embodiment is different from the first embodiment in that the manufacturing processes are made easier than the case where the ELGs are arranged close to the both sides of the main pole 31. The respective leads 71 and 73 are connected to the controller 55. For the third ELGs 63 and the leads 73, the structure and material same as those of the first ELGs 61 and the leads 71 as well as the second ELGs 62 and the leads 72 in the first embodiment can be used. The controller 55 adjusts SH of the read element 22 by carrying out lapping control while monitoring the resistance values of the first ELGs 61. The controller 55 also monitors the resistance values of the first ELGs 61 and the third ELGs 63. When a difference occurs between the resistance values of the both, the controller 55 can adjust NH of the return yoke 32 by carrying out lapping control in such a manner that a feedback circuit in the controller 55 is brought into an operation to apply pressure onto a portion of the jig above an ELG having great deviation from a desired resistance value by means of a particular piston 53 (see FIG. 5). The process flow of the lapping method in the present embodiment is similar to that of FIG. 9 described in the first embodiment. In the present embodiment as well, the same effect as in the first embodiment can be obtained.

FIG. 11 schematically shows a state that a row bar including first, second and third ELGs is set to a lapping machine in a third embodiment of the present invention. In the same way as in FIG. 8, the perpendicular write head is of a shielded pole type. A pair of first ELGs 61 is formed close to the both sides of the read element 22, and leads 71 are connected to the respective first ELGs 61. Further, a pair of second ELGs 62 is formed close to the both sides of the main pole 31, and leads 72 are connected to the respective second ELGs 62. Furthermore, a pair of third ELGs 63 is formed on the trailing side of the return yoke 32, and leads 73 are connected to the respective third ELGs 63. The respective leads 71, 72 and 73 are connected to the controller 55. The controller 55 adjusts SH of the read element 22 by carrying out lapping control while monitoring the resistance values of the first ELGs 61. The controller 55 also monitors the resistance values of the first ELGs 61, the second ELGs 62, and the third ELGs 63. When a difference occurs among these resistance values, the controller 55 can adjust NH of the return yoke 32 by carrying out lapping control in such a manner that a feedback circuit in the controller 55 is brought into an operation to apply pressure onto a portion of the jig above an ELG having great deviations from a desired resistance value by means of a particular piston 53 (see FIG. 5). This process flow of the lapping method in the present embodiment is similar to that of FIG. 9 described in the first embodiment. In the present embodiment as well, the same effect as in the first and second embodiments can be obtained.

In the above first to third embodiments, the case where SH of the read element is adjusted by monitoring the resistance values of the ELGs are described. However, SH of the read element can be adjusted by carrying out lapping control while monitoring a resistance value of the read element without using ELGs, or while monitoring both of the resistance values of the ELGs and the read element.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method of lapping a row bar in which perpendicular magnetic heads each including a read element as well as a main pole and a return yoke are formed, the method comprising:
preparing a row bar in which first lapping guides are formed close to the read element and second lapping guides are formed close to the main pole;
mounting the row bar on a lapping machine so as to allow a lapping surface of the row bar to face a lapping plate; and
carrying out lapping while controlling pressure applied to the row bar on the basis of resistance values of the first and second lapping guides.

2. The method according to claim 1, wherein the following condition is satisfied:
S|tan θ|<30 (nm),
where S is a distance from the center of the read element to the center of the main pole and that θ is an inclination angle of the lapping surface measured at the center of the main pole with respect to the center of the read element.

3. The method according to claim 2, wherein the following condition is satisfied:
S|tan θ|<10 (nm).

4. A method of lapping a row bar in which perpendicular magnetic heads each including a read element as well as a main pole and a return yoke are formed, the method comprising:
preparing a row bar in which first lapping guides are formed close to the read element and third lapping guides are formed on a trailing side of the return yoke;
mounting the row bar on a lapping machine so as to allow a lapping surface of the row bar to face a lapping plate; and
carrying out lapping while controlling pressure applied to the row bar on the basis of resistance values of the first and third lapping guides.

5. The method according to claim 4, wherein the following condition is satisfied:
S|tan θ|<30 (nm),
where S is a distance from the center of the read element to the center of the return yoke and that θ is an inclination angle of the lapping surface measured at the center of the return yoke with respect to the center of the read element.

6. The method according to claim 5, wherein the following condition is satisfied:
S|tan θ|<10 (nm).

7. A method of lapping a row bar in which perpendicular magnetic heads each including a read element as well as a main pole and a return yoke are formed, the method comprising:
preparing a row bar in which first lapping guides are formed close to the read element, second lapping guides are formed close to the main pole, and third lapping guides are formed on a trailing side of the return yoke;
mounting the row bar on a lapping machine so as to allow a lapping surface of the row bar to face a lapping plate; and
carrying out lapping while controlling pressure applied to the row bar on the basis of resistance values of the first, second, and third lapping guides.

8. The method according to claim 7, wherein the following condition is satisfied:
S|tan θ|<30 (nm),
where S is a distance from the center of the read element to the center of the main pole or the return yoke and that θ is an inclination angle of the lapping surface measured at the center of the main pole or the return yoke with respect to the center of the read element.

9. The method according to claim 8, wherein the following condition is satisfied:
S|tan θ|<10 (nm).

10. A lapping machine lapping a row bar in which perpendicular magnetic heads each including a read element as well as a main pole and a return yoke, first lapping guides close to the read element, and at least ones of second lapping guides close to the main pole and third lapping guides on a trailing side of the return yoke are formed, comprising:
a lapping plate;
a jig which holds the row bar with a lapping surface thereof facing to the lapping plate;
pistons which press the row bar through the jig; and
a controller connected to the first lapping guides, at least ones of the second lapping guides and the third lapping guides, and the pistons, which controls operations of the pistons on the basis of resistance values of the first lapping guides, and resistance values of at least ones of the second lapping guides and the third lapping guides.

11. The lapping machine according to claim 10, wherein the pistons are arranged above the respective lapping guides included in the row bar.
